(19) United States
(12) Patent Application Publication
(10) Pub. No.: US 2004/0111512 A1
(43) Pub. Date: Jun. 10, 2004

(54) Method for transmitting messages of industrial controllers to pre-defined receivers via the internet

(75) Inventor: Rainer Barth, Stuttgart (DE)

Correspondence Address: Henry M. Feiereisen, 350 Fifth Avenue, Suite 4714, New York, NY, 10118, US

(73) Assignee: SIEMENS AKTIENGESELLSCHAFT, Munchen (DE)

(21) Appl. No.: 10/659,766

(22) Filed: Sep. 10, 2003

(30) Foreign Application Priority Data
Sep. 10, 2002 (DE) 102 41 953.1

(51) Int. Cl. G06F 15/173; G06F 15/16

(52) U.S. Cl. 709/224; 709/227

(57) ABSTRACT

A method for transmitting messages from an industrial controller to a specified receiver using an Internet-related protocol is disclosed. An alarm indicating system generates, if a particular event occurs, event-relevant information. The event-relevant information is written to a database that is accessible to the specified receiver or recipient. Of the event-relevant information, only a message that an event has occurred is transmitted receiver-specific to a Web server. The specified receiver receives the message and accesses the event-relevant information in the database via a cryptographically protected communication protocol based on an Internet browser. Alternatively, a modem connection protected by an authentication protocol can be used instead of the Internet connection.

### CROSS-REFERENCES TO RELATED APPLICATIONS

This application claims the priority of German Patent Application, Serial No. 102 41 953.1, filed Sep. 10, 2002, pursuant to 35 U.S.C. 119(a)-(d), the disclosure of which is incorporated herein by reference.

### BACKGROUND OF THE INVENTION

The present invention relates to a method for securely transmitting messages of industrial controllers to pre-defined receivers via a network, such as the Internet, or via a modem connection.

Conventional numerical controllers include diagnostic modules with monitoring functions that operate either continuously or on demand, that monitor operation of the machine and/or controller for automatic documentation and for indicating alarm situations, as well as for sending messages about the operating states and their underlying causes. For example, a visual display of relevant measurement values can be indicated on the display device of the numeric controller as, for example, a curve or a diagram. Alternatively or in addition, the diagnostic results can be displayed in alphanumeric form. Such data can also be outputted via interfaces, enabling a remote diagnostics (Hans B. Kief, “NC/CNC Handbook”, 1995/96, Carl Hanser Verlag, Munich, Vienna, page 58).

It is also known to transmit reportable operating states of controllers with programmable memories. A predefined group of people can here be automatically informed about a pre-defined alarm situation as well as escape strategies, for example, via text and voice messages, and about the required actions (Special Tooling 6/99, page 60 ff. “Hier spricht lhre Steuerung” (This is your controller speaking)).

German pat. publication no. DE 199 62 230 A1 discloses a method of the afore-described type, wherein an industrial controller for machine tools, robots and/or processing machines, sends messages and/or alarms for predefined operating states to a predefined group listed on a distribution list.

The constantly increasing need for information requires machine tools and production machines or machines and systems in the industrial area which are capable of sending e-mail messages when certain events occur. Since not only the need for information increases, but also the security requirement becomes more and more important, the transmitted information must be protected from unauthorized third parties.

Conventional systems employ a public key infrastructure (PKI). However, a PKI only functions with real people and if the logistic complexity is warranted. One problem exists in that for sending an e-mail only of the public key of the recipient is required, whereas for signing the e-mail the private key of the sender is required. The machine has to be informed if the public keys of the recipients or the private key of the machine are marked as being invalid or are revoked by an issuing agency. A key typically becomes invalid or unusable after a certain time has elapsed. New keys that have to be procured and installed on each machine, which is complex and expensive. In addition, many service technicians cannot externally access their e-mail in the field, which resides in the mailbox at their company's location.

It would therefore be desirable and advantageous to provide a simple method for a transmission of messages from industrial controllers to pre-defined receivers or recipients via standard Internet links, which obviates prior art shortcomings and is able to specifically transmit such information in a secure fashion.

### SUMMARY OF THE INVENTION

According to one aspect of the present invention, a method for transmitting messages from an industrial controller to a specified receiver uses an Internet-related protocol, including the steps of employing an alarm indicating system that generates, if an event occurs, event-relevant information, and writing the event-relevant information to a database that is accessible to the specified receiver. Out of the event-relevant information, only a message that indicates that an event has occurred is transmitted receiver-specific to a Web server. The specified receiver receives the message and accesses in response to the received message the event-relevant information in the database via a cryptographically protected communication protocol using an Internet browser.

According to another aspect of the invention, a method for transmitting messages from an industrial controller to a specified receiver uses a modem connection that is protected by an authentication protocol. The method includes the steps of employing an alarm indicating system to generate, if an event occurs, event-relevant information; writing the event-relevant information to a database accessible to the specified receiver; and transmitting receiver-specific via the modem connection out of the event-relevant information only a message that indicates that an event has occurred. The specified receiver receives the message and accesses the event-relevant information in the database via a cryptographically protected communication protocol via the modem connection. In this way, if communication based on Internet browsers is not available, the sensitive information can also be transmitted from the recipients to the controller via a modem connection protected by an authentication mechanism.

According to a first advantageous feature of the invention, the cryptographically protected communication protocol can be based on an Internet browser employing a “Hypertext Transfer Protocol Security” protocol. “Hypertext Transfer Protocol Security” protocols are supported by conventional Internet browser.

According to another advantageous feature of the invention, the “Hypertext Transfer Protocol Security” protocol can include a “Secure Socket Layer” protocol or a “Transport Layer Security” protocol, since these protocols are commonly regarded as particularly secure.

Advantageously, the message can be transmitted to the specified receiver as an e-mail, an SMS or as a voice message. With this approach, the predefined receiver receives the message quickly and reliably.

According to another advantageous feature of the invention, if the message is an email message, the e-mail message can include a cross-reference, in particular a URL address, that provides a link to the receiver-specific information that is stored in the database. This provides fast and easy access to the information.

According to another advantageous feature of the invention, the event-relevant information can include event messages, fault messages and additional information, such as machine state, status and process information, as well as file attachments which can be stored in the database. In this way, the greatest possible amount of information can be made available for a subsequent failure analysis and fault repair.

Advantageously, access to the Web server can be protected by a login and a password. This further impedes unauthorized access by third parties to sensible data and supplements the afore-described cryptographic means.

According to another advantageous feature of the invention, the database and/or the Web server can be integrated with hardware of the controller, which allows a particularly cost-effective implementation of the method.

According to another advantageous feature of the invention, the database and/or the Web server can be implemented as hardware that is separate from hardware of the controller. For example, if the control hardware has insufficient computing power, then the database and/or the Web server may advantageously be implemented as separate hardware.

According to yet another advantageous feature of the invention, the data, parameters and/or programs for the controller can be transmitted from the specified receiver to the controller. In this way, the recipients can repair the faults using the same remote connection.

### BRIEF DESCRIPTION OF THE DRAWING

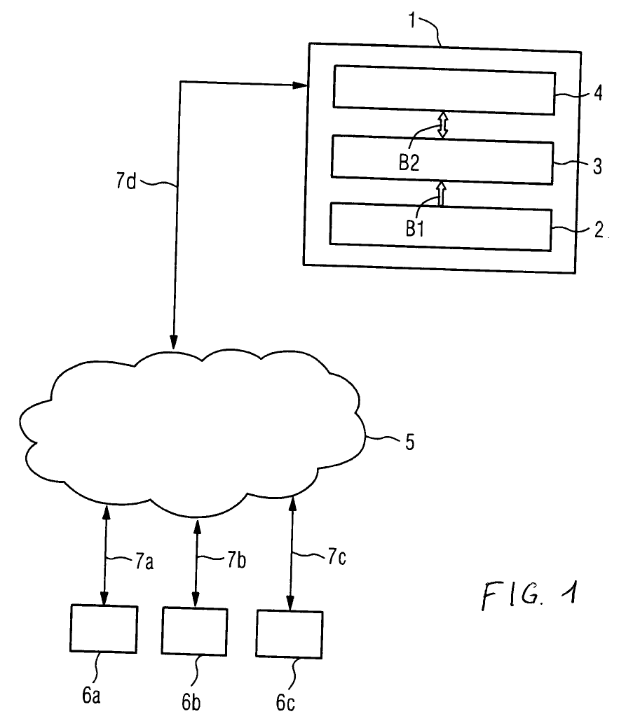

Other features and advantages of the present invention will be more readily apparent upon reading the following description of currently preferred exemplified embodiments of the invention with reference to the accompanying drawing, in which the sole FIG. 1 illustrates in form of a diagram a method according to the present invention;

### DETAILED DESCRIPTION OF PREFERRED EMBODIMENTS

The depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a block diagram of a controller 1, which also includes a Web server 4, a database 3 and an alarm indicating system 2. The controller 1 can have additional components which may not be important for the method of the invention and are therefore not illustrated for sake of clarity. The alarm indicating system 2 is connected with the database 3 via a bus system B1. The database 3 is connected with the Web server 4 via a bus system B2. The controller 1 is connected with the Internet 5 by a data line 7d. The Internet 5 it is connected via the data lines 7a, 7b and 7c to several receivers, of which only three exemplary receivers 6a, 6b and 6c are shown. The data flow directions of the bus systems B1 and B2 as well as of the data lines 7a, 7b, 7c and 7d are indicated by directional arrows. A more limited intranet can also be employed instead of the universal Internet 5.

The bus systems B1 and B2 can be implemented in hardware with corresponding software using, for example, the various layers of an ISO layer model. Alternatively, the bus system can employ a basic data communication based on defined software interfaces.

The controller 1 can be employed to control, for example, machine tools, robots and/or processing machines. If a specific event occurs, for example a component of the machine fails, the controller-internal alarm system 2 generates a time-stamped alarm message and a data set that contains event-relevant information. This information is transmitted via the bus system B1 to the database 3 and designated for a specific receiver. The alarm indicating system 2 assigns to each specific event or alarm a predefined receiver group. If a new event occurs, the alarm system 2 transmits an e-mail, SMS (“Short Message Service”) or a voice message via the Internet 5 to the specified receivers for the respective event, e.g. 6a, 6b and 6c. The receivers 6a, 6b and 6c all only informed that such event has occurred. The e-mail, the SMS or the voice message themselves do not contain any sensitive information. When the receiver or recipient, e.g. a service technician, receives to the corresponding e-mail, SMS or the voice mail, the technician establishes via the Internet 5 a connection, that is secured by cryptographic means, to the Web server 4 using an Internet browser, for example an Internet-capable terminal, running a “Hypertext Transfer Protocol Security” protocol. The “Hypertext Transfer Protocol Security” protocol can be implemented, for example, via a “Secure Socket Layer” protocol or a “Transport Layer Security” protocol.

To provide additional security against unauthorized access by third parties, the Web server can furthermore be protected with a login prompt and password. After such secure connection has been established, the recipients can read and optionally download the information stored in the database and thereby establish a fault diagnosis.

Optionally, the receivers 6a, 6b or 6c can subsequently upload data, parameters or programs to the controller 1 via the Web server 4 for eliminating faults.

If an Internet connection to the Internet 5 is not available via an Internet browser on the receiver side, then a connection between the receivers 6a, 6b or 6c and the database 3 could be established using a modem connection that is protected by an authentication mechanism. The controller can, of course, also be equipped with additional modems (not shown).

According to one embodiment, the message generated by the alarm indicating system 3 can be sent to the predefined recipients 6a, 6b or 6c in the form of an e-mail message which may include a cross-reference, for example in form of a URL (Universal Resource Locator) address, to the event-relevant information that is stored recipient-specific in a database element of the database 3.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for transmitting messages from an industrial controller to a specified receiver using an Internet-related protocol, comprising the steps of:
generating with an alarm indicating system, if a specified event occurs, event-relevant information;
writing the event-relevant information to a database accessible to the specified receiver;
transmitting receiver-specific to a Web server out of the event-relevant information only a message indicating that an event has occurred; and
receiving the message at the specified receiver, with the specified receiver accessing the event-relevant information in the database via a cryptographically protected communication protocol based on an Internet browser.

2. The method of claim 1, wherein the cryptographically protected communication protocol implemented in an Internet browser comprises a “Hypertext Transfer Protocol Security” protocol.

3. The method of claim 2, wherein the “Hypertext Transfer Protocol Security” protocol comprises a “Secure Socket Layer” protocol or a “Transport Layer Security” protocol.

4. The method of claim 1, wherein the message is transmitted to the specified receiver as an e-mail, an SMS or as a voice message.

5. The method of claim 4, wherein an e-mail message includes a cross-reference, in particular a URL address, that provides a link to the receiver-specific information that is stored in the database.

6. The method of claim 1, wherein the event-relevant information comprises event messages, fault messages and additional information, such as machine status, status and process information, as well as file attachments which are stored in the database.

7. The method of claim 1, wherein access to the Web server is protected by a login prompt and a password.

8. The method of claim 1, wherein at least one of the database and the Web server are integrated with hardware of the controller.

9. The method of claim 1, wherein at least one of the database and the Web server are implemented as hardware that is separate from hardware of the controller.

10. The method of claim 1, wherein at least one of data, parameters and programs for the controller are transmitted from the specified receiver to the controller.

11. A method for transmitting messages from an industrial controller to a specified receiver using a modem connection protected by an authentication protocol, comprising the steps of:
generating with an alarm indicating system, if an event occurs, event-relevant information;
writing the event-relevant information to a database accessible to the specified receiver;
transmitting receiver-specific via the modem connection out of the event-relevant information only a message indicating that an event has occurred; and
receiving the message at the specified receiver, with the specified receiver accessing the event-relevant information in the database via a cryptographically protected communication protocol via the modem connection.
